(19) United States
(12) Patent Application Publication
(10) Pub. No.: US 2006/0294006 A1
(43) Pub. Date: Dec. 28, 2006

(54) Business transaction process controller for composite transactions

(75) Inventor: Kwong Tsang, Markham (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/168,853

(22) Filed: Jun. 28, 2005

(51) Int. Cl. G06Q 40/00

(52) U.S. Cl. 705/39

(57) ABSTRACT

Embodiments of the invention provide a method, system and apparatus for commerce transaction control for composite transactions. In a method of the invention, an object model of relationships between different transactions in a composition of transactions can be generated. The object model can be traversed and at least one transaction can be invoked through a remote interface for the transaction. It can be determined whether to commit or roll-back a result of the transaction in the composition based upon a results tree holding results for other invoked transactions in the composition. Consequently, the result of the transaction in the composition can be committed or rolled-back according to the determining step.

### BACKGROUND OF THE INVENTION

1. Field of the Invention

The present invention relates to the field of commerce systems and more particularly to the field of transaction processing for composite transactions.

2. Description of the Related Art

Commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

Commerce systems generally involve the completion of one or more transactions. Transactions can range from the completion of a single, independent task, such as the purchase of a single product or service, to the completion only of a single dependent task among several dependent tasks. Notably, where a transaction involves only a single task, the transaction controller for the commerce system can manage the single task with regard for the state of other tasks. On the other hand, where a transaction relates to the state of other tasks, the collection of the interdependent tasks can be viewed as a composition. To add to the complexity, modern commerce systems can involve variable combinations of both independent transactions and composite transactions.

The distributed nature of commerce systems has given rise to transaction processing involving multiple disparate entities. Specifically, no longer can it be presumed that all tasks in a composed transaction are to be performed by a single host entity. Rather, in the more likely scenario, different tasks in a composed transaction can be performed by different hosts across a data communications network through a remote access interface to the hosts. In consequence, for the transaction controller, monitoring the progress of each task can be difficult at best in that the progress of each task usually is known by the host and not the controller. To the extent that any one task in a composite transaction depends upon the successful completion of another task hosted by a different host, the problem can become compounded.

At present, transactions are processed within the commerce system irrespective of the nature of the transaction. In this regard, independent transactions are treated no differently than transactions that are dependent upon other transactions. Yet, for many commerce system users, the satisfactory completion of all tasks in a composite transaction is expected and the failure to complete any one of the tasks in a composite transaction is cause for considering the entire transaction to have failed. Thus, commerce system operators often must resort to the manual tracking of the state of the tasks in a composite transaction and the manual computation of when a composite transaction is considered to have failed.

Where a composite transaction has failed due to the failure of a task in the composition, a portion or all of the transaction must be rolled back to a stable state. As such, to manually track the relationship between different tasks in a transaction can be that much more difficult—especially in the distributed circumstance where different tasks are invoked in different host platforms through different remote access interfaces. Accordingly, it would be desirable to simplify and standardize the process of controlling complex commerce transactions so that the control of transactions can be expandable, configurable and manageable.

### BRIEF SUMMARY OF THE INVENTION

Embodiments of the present invention address deficiencies of the art in respect to composite transaction management and provide a novel and non-obvious method, system and apparatus for commerce transaction control for composite transactions. In one embodiment, an object model of relationships between different transactions in a composition of transactions can be generated. The object model can be traversed and at least one transaction can be invoked through a remote interface for the transaction. It can be determined whether to commit or roll-back a result of the transaction in the composition based upon a results tree holding results for other invoked transactions in the composition. Consequently, the result of the transaction in the composition can be committed or rolled-back according to the determining step.

The generating step can include parsing a markup language document to identify the relationships and producing the object model using the identified relationships. The generating step in turn can include generating an object model of relationships between different transactions in a composition of transactions. The object model can include a set of nodes arranged according to the relationships selected from one of independent transactions, transactions that are co-dependent upon one another, transactions that are dependent upon other transactions, transactions that are to be invoked sequentially, and transactions that are to be invoked in parallel.

The determining step can include determining whether to commit or roll-back a result of the transaction in the composition based upon whether a result in the results tree for a previously invoked transaction in sequence with a currently invoked transaction has failed and whether the currently invoked transaction is dependent upon the result in the results tree for the previously invoked transaction. Likewise, the determining step can include determining whether to commit or roll-back based upon whether a result in the results tree for a currently invoked transaction in sequence with a previously invoked transaction has failed and whether the previously invoked transaction is dependent upon the result in the results tree for the currently invoked transaction. The determining step yet further can include determining whether to commit or roll-back based upon whether a result in the results tree for a previously invoked transaction in parallel with a currently invoked transaction has failed and whether the currently invoked transaction is dependent upon the result in the results tree for the previously invoked transaction.

In another embodiment, a system for commerce transaction control for composite transactions can include an object model of relationships between different transactions in a composition of transactions, a results tree holding results for invoked transactions in the composition, and a business transaction control processor coupled to the object model and the results tree. The business transaction control process can include programming to generate the object model, to traverse the object model, to invoke at least one transaction through a remote interface for the at least one transaction, to determine whether to commit or roll-back a result of the at least one transaction in the composition based upon the results tree, and to commit or roll-back the result of the at least one transaction in the composition according to the determination.

The object model can be derived from a markup language document defining the relationships. The results tree can be a hierarchical arrangement of nodes. The results tree also can be a table. In either case, the relationships can include relationships such as independent transactions, transactions that are co-dependent upon one another, transactions that are dependent upon other transactions, transactions that are to be invoked sequentially, and transactions that are to be invoked in parallel.

Additional aspects of the invention will be set forth in part in the description that follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for commerce transaction control for composite transactions;

FIG. 2 is a block diagram illustrating commerce transaction control for composite transactions in the system of FIG. 1; and

FIG. 3 is a flow chart illustrating a process for commerce transaction control for composite transactions in the system of FIG. 1.

### DETAILED DESCRIPTION OF THE INVENTION

Embodiments of the present invention provide a method, system and apparatus for managing composite transactions in a commerce system. In accordance with one embodiment, a composition of transactions forming a composite transaction can be transformed into an object model that represents relationships between each transaction in the composition. The relationships in particular can indicate one-way and two-way interdependencies between the transactions and also which transactions are to be performed serially and which can be performed concurrently. Using the object model, the transactions in the composition can be executed and results can be placed in a results tree reflecting the hierarchy of the object model.

At each execution of a transaction in the composition, the results tree can be consulted to determine whether to roll-back one or more previously executed transactions, or whether to commit the previously executed transactions. In this way, the state of each transaction in the composition need not be manually tracked. Moreover, more complex hierarchical dependencies between transactions in the composition need not render the management of the composition impossible. Rather, at each stage of execution, the transactions of the composition can be rolled-back to accommodate a failure in any one of the down-stream transactions.

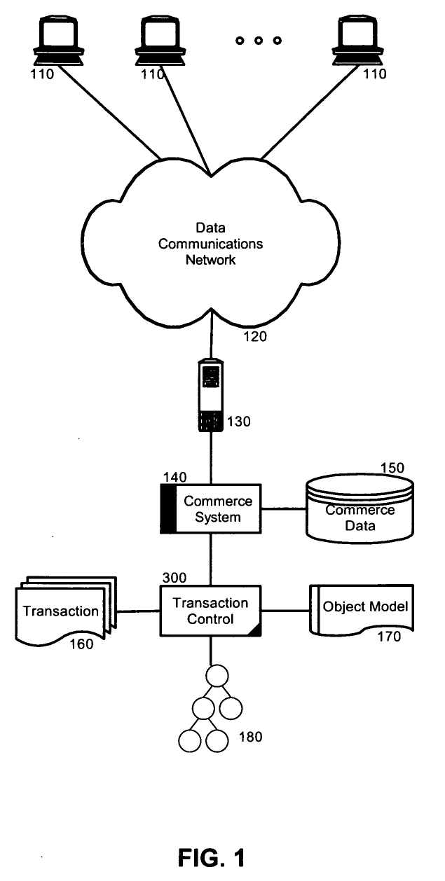

In further illustration, FIG. 1 is a schematic illustration of a system for commerce transaction control for composite transactions. The system can include a commerce system 140 hosted within a server platform 130. One or more commerce clients 110 can be communicatively linked to the commerce system 140 in the server platform 130 over a data communications network 120. To support commerce interactions in the commerce system 140, a data store of commerce data 150 can be coupled to the commerce system 140 for use by the commerce system 140.

The commerce system 140 can be configured to process composite transactions through remote interfaces to each transaction in the composition. Specifically, transaction control logic 300 can be included in the commerce system 140. The transaction control logic 300 can be programmed to manage the execution of a composition of transactions 160. In particular, the transaction control logic 300 can produce an object model 170 of the composition of the transactions 160 to represent the relationship between each of the transactions 160 in the composition. Using the object model 170, the transaction control logic 300 can call the execution of each of the transactions 160 through a remote interface to each of the transactions 160 and the result of each of the transactions 160 can be stored in a results tree 180.

The results tree 180 can include a hierarchical structure that mimics the hierarchical structure of the object model 170. As results are accumulated in the results tree 180, the interdependencies of the transactions 160 in the composition can determine whether the outcome of any one of the transactions 160 can be committed or rolled-back. For instance, prior to calling the execution of a downstream one of the transactions 160 that is dependent upon the result of the execution of an upstream one of the transactions 160, the result of the execution of the upstream one of the transactions 160 can be inspected in the results tree 180 to determine whether the upstream one of the transactions 160 had completed successfully. If not, the upstream one of the transactions 160 along with other dependent ones of the transactions 160 can be rolled back.

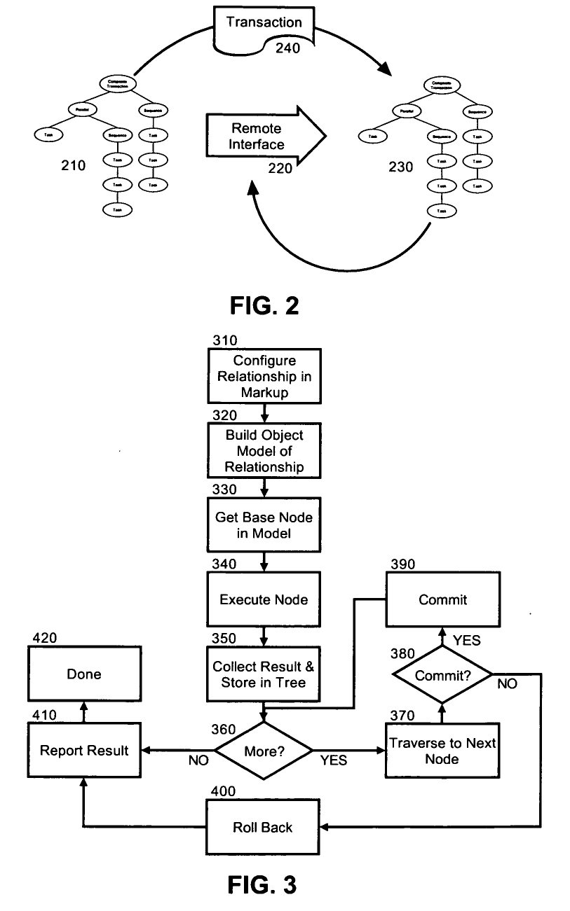

To facilitate the operation of the transaction control logic 300, a set of relationships can be defined between each of the transactions 160. For instance, the relationships can be defined in a markup language document formatted according to the extensible markup language (XML) specification. At runtime, the transaction control logic 300 can use markup language document to build the object model 170. In more particular illustration, FIG. 2 is a block diagram illustrating commerce transaction control for composite transactions in the system of FIG. 1. As shown in FIG. 2, an object model 210 of composite transactions can be created according to the defined relationship between different transactions in the composition.

Specifically, in a particular aspect of the invention, four relationship types can be defined. In a first relationship, a first transaction can depend on a second, but the second transaction need not depend upon the first. In a second relationship, both a first and a second transaction process can depend upon each other and the sequence of execution of the transactions must be maintained. In a third relationship, both a first and a second transaction process can depend upon each other and the sequence of execution of the transactions need not be maintained. Finally, in a fourth relationship, a first and a second transaction do not depend upon each other and can be performed concurrently in parallel.

Once created, the object model 210 can be traversed and each transaction 240 can be invoked through a remote interface 220. The result of each invocation can be stored in a results tree 230. The results tree 230, in turn can be evaluated when processing a next transaction in the object model 210. Depending upon the result of the previous invocation of a previous transaction and the relationship of a current transaction as defined by the object model 210, the previous transaction can be rolled-back or committed. If committed, the current transaction can be invoked through the remote interface 220 with the result of the invocation being placed in the results tree 230. Once again, the process can repeat until the object model 210 has been traversed or until an error condition requires the termination of processing.

To facilitate the creation and processing of the object model 210, in one aspect of the invention, four process elements can be created wherein each process element can be a data structure representing a building block of the object model. A node process element can be an end node that carries a reference to the actual process to be invoked through a remote interface. Specifically, the process can be a transaction in a composition of transactions, for example a shipping calculation and tax calculation during order preparation. The node process element also can include the specific error handling definition of each remote process, such as rolling-back the transaction when required.

A sequential group process element can hold other node process elements. In a sequential group process element, included node process elements can be processed in sequence. If anyone of the transactions in an included node process element fails, the sequential group process element can discontinue processing the subsequent node process elements and an error handling process can be initiated. Notably, the sequential group process element can accommodate both the first and second relationships described above between transactions in a composition.

A parallel dependent group process element also can hold other node process elements. In a parallel dependent group process element, included node process elements can be processed in parallel. The failure of any one or more included node process elements can result in the failure of the other node process elements as the same level. Accordingly, the parallel dependent group process element can accommodate the third relationship described above between transactions in a composition.

Finally, a parallel independent group process element can hold other node process elements that can be processed in parallel. Each of the included node process elements can be treated as not depending upon one another and the failure of any one or more of the included node process elements will not cause the failure of the other node process elements. Accordingly, the parallel independent group process element can accommodate the fourth relationship described above between transactions in a composition.

FIG. 3 is a flow chart illustrating a process for commerce transaction control for composite transactions in the system of FIG. 1. Beginning in block 310, a relationship between different transactions in a hierarchical composition of transactions can be configured and in block 320, an object model of the relationship can be constructed. Notably, the object model can have a hierarchical arrangement of nodes defining at least one of a collection of independent transactions, sequentially dependent transactions and concurrently dependent transactions.

In block 330, a base node in the object model can be retrieved for processing. In block 340, the transaction represented by the node can be invoked through a remote interface to remotely disposed logic and in block 350, the result of the remotely invoked transaction can be collected and stored in a hierarchical results tree. In decision block 360, if additional nodes in the object model remain to be processed, in block 370 the next node in the object model can be retrieved, executed and a result can be collected in the results tree.

In decision block 380, it can be determined whether or not to commit the result of the transaction based upon the relationship of the object model. For example, if the transaction of the current node is dependent upon the successful completion of the transaction of the previous node, and the transaction of the previous node has failed, then the result of the current transaction can be rolled-back in block 400. By comparison, if the transaction of the current node is not dependent upon the successful completion of the transaction of the previous node, regardless of whether the transaction of the previous node has failed, the result of the current transaction can be committed in block 390.

In any event, the process can repeat as each node in the tree is traversed until no further nodes remain to be processed in the object model. When no further nodes remain to be processed in the object model, in block 410 the result of the execution of the composite transaction can be reported and the process can end in block 420.

Embodiments of the invention can take the form of an entirely hardware embodiment, an entirely software embodiment or an embodiment containing both hardware and software elements. In a preferred embodiment, the invention is implemented in software, that includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

We claim:

1. A commerce transaction control method for composite transactions, comprising:
generating an object model of relationships between different transactions in a composition of transactions;
traversing said object model and invoking at least one transaction through a remote interface for said at least one transaction;
determining whether to perform one of a commit and a roll-back of a result of said at least one transaction in said composition based upon a results tree holding results for other invoked transactions in said composition; and,
committing said result of said at least one transaction in said composition according to said determining step.

2. The method of claim 1, wherein said generating step further:
parsing a markup language document to identify said relationships; and,
producing said object model using said identified relationships.

3. The method of claim 1, wherein said generating step further comprises:
generating an object model of relationships between different transactions in a composition of transactions, said object model comprising a set of nodes arranged according to said relationships selected from the group consisting of independent transactions, transactions that are co-dependent upon one another, transactions that are dependent upon other transactions, transactions that are to be invoked sequentially, and transactions that are to be invoked in parallel.

4. The method of claim 3, wherein said determining step further comprises:
determining whether to perform one of a commit and a roll-back of a result of said at least one transaction in said composition based upon whether a result in said results tree for a previously invoked transaction in sequence with a currently invoked transaction has failed and whether said currently invoked transaction is dependent upon said result in said results tree for said previously invoked transaction.

5. The method of claim 3, wherein said determining step further comprises:
determining whether to perform one of a commit and a roll-back of a result of said at least one transaction in said composition based upon whether a result in said results tree for a currently invoked transaction in sequence with a previously invoked transaction has failed and whether said previously invoked transaction is dependent upon said result in said results tree for said currently invoked transaction.

6. The method of claim 3, wherein said determining step further comprises:
determining whether to perform one of a commit and a roll-back of a result of said at least one transaction in said composition based upon whether a result in said results tree for a previously invoked transaction in parallel with a currently invoked transaction has failed and whether said currently invoked transaction is dependent upon said result in said results tree for said previously invoked transaction.

7. The method of claim 1, further comprising rolling-back said result of said at least one transaction in said composition according to said determining step.

8. A data processing system for commerce transaction control for composite transactions, the data processing system comprising:
an object model of relationships between different transactions in a composition of transactions;
a results tree holding results for invoked transactions in said composition; and,
a business transaction control processor coupled to said object model and said results tree, said business transaction control process having programming to generate said object model, to traverse said object model, to invoke at least one transaction through a remote interface for said at least one transaction, to determine whether to perform one of a commit and a roll-back of a result of said at least one transaction in said composition based upon said results tree, and to perform one of a commit and a roll-back of said result of said at least one transaction in said composition according to said determination.

9. The data processing system of claim 8, wherein said object model is derived from a markup language document defining said relationships.

10. The data processing system of claim 8, wherein said results tree is a hierarchical arrangement of nodes.

11. The data processing system of claim 8, wherein said results tree is a table.

12. The data processing system of claim 8, wherein said relationships comprise relationships selected from the group consisting of independent transactions, transactions that are co-dependent upon one another, transactions that are dependent upon other transactions, transactions that are to be invoked sequentially, and transactions that are to be invoked in parallel.

13. A computer program product for commerce transaction control for composite transactions, comprising a computer usable medium embodying computer usable program code thereon, said computer program product comprising:
computer usable program code for generating an object model of relationships between different transactions in a composition of transactions;
computer usable program code for traversing said object model and invoking at least one transaction through a remote interface for said at least one transaction;
computer usable program code for determining whether to perform one of a commit and a roll-back of a result of said at least one transaction in said composition based upon a results tree holding results for other invoked transactions in said composition; and,
computer usable program code for committing said result of said at least one transaction in said composition according to said determining step.

14. The computer program product of claim 13, wherein said computer usable program code for generating an object model of relationships between different transactions in a composition of transactions further comprises:
computer usable program code for parsing a markup language document to identify said relationships; and,
computer usable program code for producing said object model using said identified relationships.

15. The computer program product of claim 13, wherein said computer usable program code for generating an object model of relationships between different transactions in a composition of transactions further comprises computer usable program code for generating an object model of relationships between different transactions in a composition of transactions, said object model comprising a set of nodes arranged according to said relationships selected from the group consisting of independent transactions, transactions that are co-dependent upon one another, transactions that are dependent upon other transactions, transactions that are to be invoked sequentially, and transactions that are to be invoked in parallel.

16. The computer program product of claim 15, wherein said computer usable program code for determining whether to perform one of a commit and a roll-back of a result of said at least one transaction in said composition based upon a results tree holding results for other invoked transactions in said composition comprises computer usable program code for determining whether to perform one of a commit and a roll-back of a result of said at least one transaction in said composition based upon whether a result in said results tree for a previously invoked transaction in sequence with a currently invoked transaction has failed and whether said currently invoked transaction is dependent upon said result in said results tree for said previously invoked transaction.

17. The computer program product of claim 15, wherein said computer usable program code for determining whether to perform one of a commit and a roll-back of a result of said at least one transaction in said composition based upon a results tree holding results for other invoked transactions in said composition comprises computer usable program code for determining whether to perform one of a commit and a roll-back of a result of said at least one transaction in said composition based upon whether a result in said results tree for a currently invoked transaction in sequence with a previously invoked transaction has failed and whether said previously invoked transaction is dependent upon said result in said results tree for said currently invoked transaction.

18. The computer program product of claim 15, wherein said computer usable program code for determining whether to perform one of a commit and a roll-back of a result of said at least one transaction in said composition based upon a results tree holding results for other invoked transactions in said composition comprises computer usable program code for determining whether to perform one of a commit and a roll-back of a result of said at least one transaction in said composition based upon whether a result in said results tree for a previously invoked transaction in parallel with a currently invoked transaction has failed and whether said currently invoked transaction is dependent upon said result in said results tree for said previously invoked transaction.

19. The computer program product of claim 13, further comprising computer usable program code for rolling-back said result of said at least one transaction in said composition according to said determining step.
